(19) United States
(12) Patent Application Publication
(10) Pub. No.: US 2003/0016282 A1
(43) Pub. Date: Jan. 23, 2003

(54) Thermochromic writing device

(76) Inventor: David H. Koizumi, Portland, OR (US)

Correspondence Address: Timothy N. Trop, TROP, PRUNER & HU, P.C., 8554 KATY FWY, STE 100, HOUSTON, TX, 77024-1805, US

(21) Appl. No.: 09/907,194

(22) Filed: Jul. 17, 2001

(51) Int. Cl. B41J 2/40; G09G 5/00

(52) U.S. Cl. 347/143; 438/347

(57) ABSTRACT

A writing tablet may be covered with a thermochromic writing surface so that the user may temporarily mark on the writing surface by changing its temperature. In one embodiment, the writing surface may be positioned over a processor-based device. The processor-based device, using a touch screen, for example, may detect the writing on the writing surface and may receive that writing as a touch screen input.

### BACKGROUND

This invention relates generally to writing devices including display tablets and the like, as well as, electronic devices such as processor-based systems.

In a number of applications, conventional writing implements have serious disadvantages. For example, when children use writing instruments, there is a tendency for the writing material to end up in a variety of places, including on the children's person, on the children's clothing and on other articles in addition to paper or other writing tablets. Also, in a variety of writing situations, the consumables involved may become expensive over time.

Indirect writing products such as the Etch-a-sketch® writing product overcome some of these disadvantages, while creating their own problems. The Etch-a-sketch® product, for example, avoids the problem of consumables and the problem of cleaning up writing materials. However, the Etch-a-sketch® product is generally limiting in what can be written and requires some coordination to write or draw more elaborate shapes. In effect, the Etch-a-sketch® product constrains children to relatively limited movements and therefore, is less than optimal.

Thus, there is a need for a writing device which enables unconstrained creation while avoiding the problems associated with consumable writing materials.

### BRIEF DESCRIPTION OF THE DRAWINGS

FIG. 1 is a perspective view of one embodiment of the present invention;

FIG. 2 is a perspective view of another embodiment of the present invention;

FIG. 3 is a schematic depiction of the embodiment shown in FIG. 2; and

FIG. 4 is a schematic depiction of another embodiment of the present invention.

### DETAILED DESCRIPTION

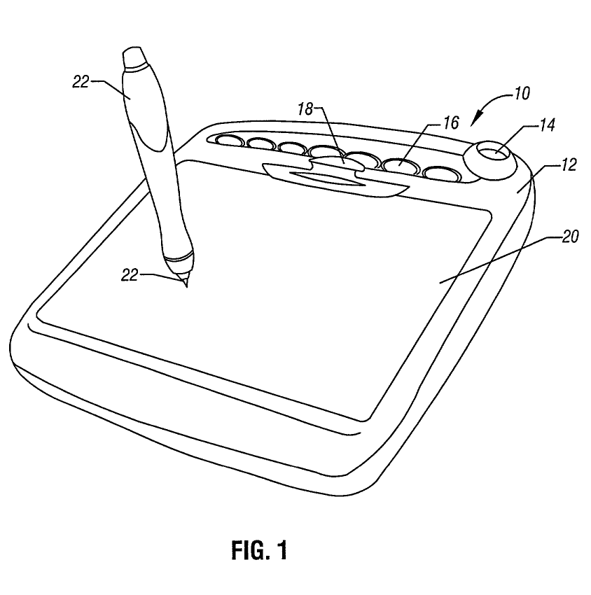

Referring to FIG. 1, a writing tablet 10 may include a replaceable writing sheet 20 held on the writing surface 12 of the tablet 10 by way of a spring clip 18. Other techniques may be utilized to removeably secure the writing sheet 20 on the surface 12, including friction, adhesive and a variety of other clips and attachment devices. In other embodiments, the sheet 12 may be integrated into the tablet 10.

In some embodiments, the writing tablet 10 may be a processor-based device such as a personal computer, a laptop computer, a personal digital assistant, or a cellular phone, to mention a few examples. In some embodiments, the writing sheet 20 may underlie a display screen of a processor-based device. In some embodiments, that display screen may be a touch sensitive display screen.

The writing sheet 20 may be formed of a thermochromic material. The thermochromic material may, in one embodiment, be formed as a plastic sheet. Thermochromic materials are materials which change color in response to changing temperature. In some embodiments, the thermochromic materials are in the form of inks encapsulated within capsules formed in the writing sheet 20. However, any technique for implementing thermochromism is suitable in connection with the present invention.

Generally, thermochromic material has at least two different color states called the hot color state and the cold color state. The difference between the two states is the color which the material exhibits. Thermochromic materials are available in a wide variety of different colors. When heated, the material takes its higher temperature color state and when cooled, the material may take its lower temperature color state. Thus, by heating or cooling the writing sheet 20, its color may be changed, enabling the user to write or draw on the writing sheet 20. The thermochromic color change may be temporary and may disappear after a short time.

The user may write on the writing sheet 20 using a writing instrument in one embodiment 22. The writing instrument 22 may include a tip 23 that is heated to cause the color transformation in the writing sheet 20. In one embodiment, the writing instrument 22 may be stored in a tubular holder 14 when not in use. In a processor-based embodiment, a plurality of buttons 16 may be provided to select functions of a processor-based system.

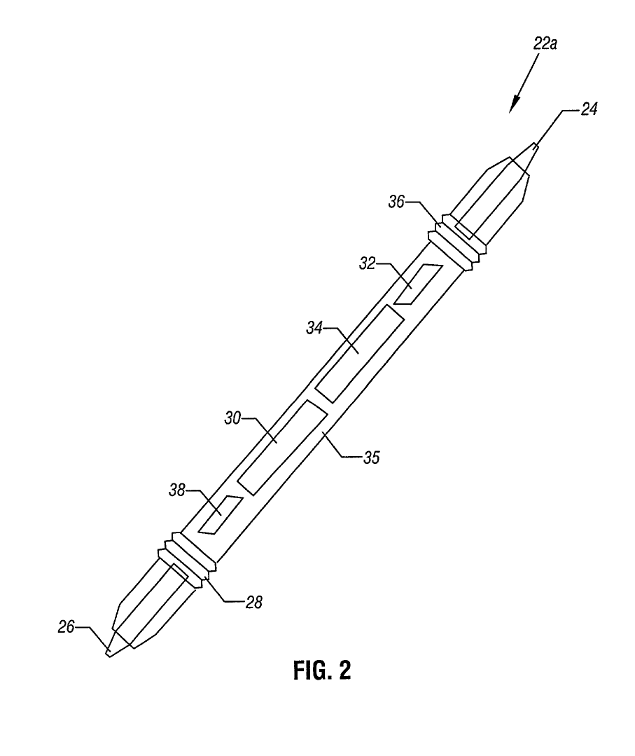

Referring next to FIG. 2, another embodiment of a writing instrument 22a includes a pair of opposed, temperature controlled ends 24 and 26. In one embodiment, the end 26 is a heated end to activate the hot color state of the writing sheet 20. The end 24 is a cooled end to activate the cold color state of the writing sheet 20.

In one embodiment, a heating element 28 may be associated with the end 26 to raise its temperature to the hot color state temperature range of the writing sheet 20. The heating element 28 may be a Peltier element, a thermister, or a thin film heating element, to mention a few examples. Conversely, the cooling end 24 may use the same types of technology, in one embodiment, as the cooling element 36.

Thermostats 32 and 38 may be provided for the elements 36 and 28, respectively. Batteries 30 and 34 may be utilized to provide power to the elements 32, 30, 38, 36 and 28. In some embodiments, a shaft 35 may be provided, that may be made of a heat sink material such as aluminum. When Peltier elements are utilized for the elements 36 and 28, heat flows from the end 24 to the end 26.

In some embodiments, the hot end 26 may be about 40° F. to 50° F. above ambient. The hot end 26 may cause the thermochromic die in the writing sheet 20 to change to a selectable color while the cold end 24 changes the sheet 20 to another selectable color. As a result, transient writing, drawing, or marking on the sheet 20 may be implemented.

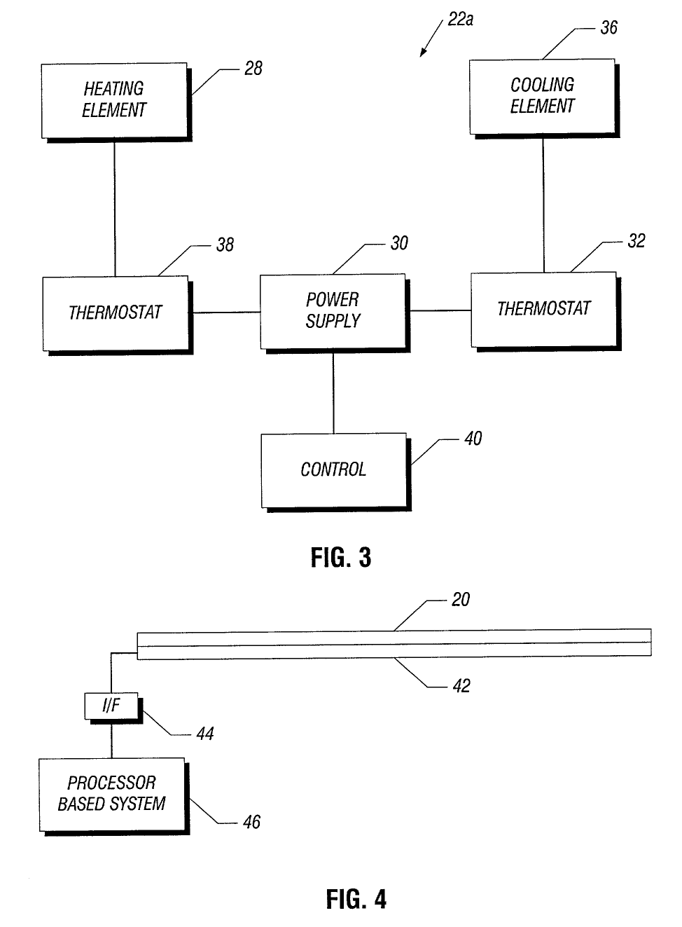

Referring to FIG. 3, the writing instrument 22a may include the heating elements 28 and 36 coupled to thermostats 38 and 32, respectively. The thermostats 38, 32 control the temperature of their respective elements 28 and 36. The thermostats 38, 32 may receive power from a power supply 30 such as the batteries 30 and 34. A controller 40 may be provided in some embodiments to adjust the temperature of the hot and cold ends 26 and 24 by adjusting signals to the thermostats 38 and 32.

Turning finally to FIG. 4, in one embodiment, the writing tablet 10 may include a touch screen 42. The writing sheet 20 may be secured over the touch screen 42, for example, using the spring clip 18 in one embodiment. Then, when the user writes on the sheet 20, the contact with the touch screen 42 may be detected and passed through an interface 44 to a processor-based system 46. The processor-based system 46 may read the writing on the sheet 20 as a conventional touch screen input. However, through the use of the temporary color change on the surface 20, the user better knows where the user has already provided an input. However, because the writing eventually disappears, the surface 20 may be repeatedly reused to reenter material into the processor-based system 46.

Thus, some embodiments may display a typed version of what the user entered rather than the user's handwritten input. This is because the handwritten version is temporarily visible via the sheet 20.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing a thermochromic writing surface that temporarily displays writing; and
detecting the writing on said temporary writing surface; and
recording the writing in an electronic device.

2. The method of claim 1 including enabling a thermochromic writing surface to be removeably attached to an electronic device.

3. The method of claim 1 including using a touch screen to detect the writing.

4. The method of claim 1 including converting hand written text into typewritten text and displaying typewritten text.

5. The method of claim 1 including enabling the writing surface to assume two different color states.

6. The method of claim 1 including providing a writing instrument with at least one heated end.

7. The method of claim 7 including providing a writing instrument with a heated end and a cooled end.

8. A system comprising:
a processor-based device; and
a housing for said processor-based device, said housing including a surface to receive a thermochromic writing sheet.

9. The system of claim 8 including a device to removeably secure a thermochromic writing sheet to said surface.

10. The system of claim 8 including a display screen.

11. The system of claim 10 wherein said display screen forms said writing surface.

12. The system of claim 8 including a spring clip to hold the thermochromic sheet on the writing surface.

13. The system of claim 8 including a display screen, said display screen being a touch screen.

14. The system of claim 13 wherein said display screen forms the writing surface.

15. The system of claim 8 including a thermochromic writing instrument.

16. The system of claim 15 wherein said thermochromic writing instrument includes a heated end.

17. The system of claim 16 wherein said thermochromic writing instrument includes a cooled end.

18. The system of claim 16 wherein said writing instrument includes a Peltier element.

19. The system of claim 8 including a thermochromic sheet.

20. A system comprising:
a housing;
a writing surface defined on said housing; and
a thermochromic sheet secured on said writing surface to enable a user to write on said thermochromic sheet by selectively applying heat to said thermochromic sheet.

21. The device of claim 20 including a thermochromic writing instrument.

22. The device of claim 21 wherein said thermochromic writing instrument includes a heated end.

23. The device of claim 22 wherein said writing instrument includes a heated end and a cooled end.

24. The device of claim 20 including a processor-based device formed in said housing.

25. The device of claim 24 wherein said writing surface forms a display screen for said processor-based device.

26. The device of claim 20 including a retainer to removeably secure said thermochromic sheet to said surface.

27. A writing instrument comprising:
a shaft;
a heated end secured to one end of said shaft; and
a cooled end secured to the other end of said shaft.

28. The instrument of claim 27 including a Peltier element that transfers heat from said cooled end to said heated end.

29. A method comprising:
enabling a user to selectively write on a thermochromic sheet; and
removeably securing said thermochromic sheet to a work surface.

30. The method of claim 29 including enabling the user to selectively heat or cool said thermochromic sheet to change the color of said sheet.
